(19) United States
(12) Patent Application Publication
(10) Pub. No.: US 2010/0281753 A1
(43) Pub. Date: Nov. 11, 2010

(54) Illuminated fishing rod

(76) Inventor: Francis M. Gonzagowski, Van Buren, AR (US)

Correspondence Address: LITMAN LAW OFFICES, LTD., PATENT LAW BUILDING, 8955 CENTER STREET, MANASSAS, VA, 20110, US

(21) Appl. No.: 12/662,782

(22) Filed: May 3, 2010

Related U.S. Application Data
(60) Provisional application No. 61/213,089, filed on May 6, 2009.

(51) Int. Cl. A01K 87/00; H05B 37/00; A01K 97/12

(52) U.S. Cl. 43/17.5; 43/18.1 R; 43/17

(57) ABSTRACT

The illuminated fishing rod is elongated and flexible, having a handle end and a free end distal from the handle end. A handle includes a forward end secured to the rod's fixed end. First and second light sources are disposed on the handle. The first light source is aligned along a first radial projection from an axial center of the elongated hollow handle. The second light source is aligned along a second radial projection from the axial center of the elongated hollow handle. The first and second light sources project first and second light beams, respectively, away from the handle. A third light source is attached to the rod proximate the free distal end. The third light source projects a third light beam away from the free distal end of the elongated hollow fishing rod. The third light beam has a different color from both first and second light beams.

### CROSS-REFERENCE TO RELATED APPLICATION

This application claims the benefit of U.S. Provisional Patent Application Ser. No. 61/213,089, filed May 6, 2009.

### BACKGROUND OF THE INVENTION

1. Field of the Invention

The present invention relates generally to fishing equipment, and more particularly to an illuminated fishing rod.

2. Description of the Related Art

Fishing is principally carried out with the use of lure attached to a fishing line cast by the use of a long, flexible fishing rod, and a reel about which the fishing line is wound. The fishing line is cast by the rod, which, in turn, propels the lure. The lure wielded by the fishing line influenced by the fisherman in the use of the fishing pole is furnished with a hook. A strike occurs when a fish takes the lure into its mouth for consumption. When a strike to the lure occurs, action on the lure by the fish acts on the fishing line, which, in turn, acts on the fishing rod causing the tip of the rod to tremble. At the moment of a strike, an attentive fisherman visualizing the trembling in the tip of the fishing rod coupled with an associated pulling force applied to the fishing rod will normally pull the rod upwardly in a quick, brief stroke in order to set the hook into the fish's mouth, at which point the fish is then reeled in by the fisherman by reeling in the fishing line with the fishing reel.

Although daytime fishing is preferred among most fisherman, fishing during periods of low ambient sunlight, such as in the early morning and the late evening, often prove to be more productive. The difficulty with fishing in dark and low light conditions rests principally with the inability for the fisherman to see the tip of his fishing pole and the difficulty in seeing fish when caught and removing lures from the mouths of caught fish. Accordingly, what is needed is a fishing pole with lighting features which allow a fisherman to easily visualize the tip of his fishing pole in dark and low light conditions, and that also provides broad illumination in the vicinity of the fishing pole for illuminating areas in and around the fishing pole where fish are reeled in thereby aiding a fisherman in easily seeing caught fish and removing lures from the mouths of caught fish. Moreover, it would be desirable if the fisherman could distinguish the difference between the tip of his pole and the handle portion of his pole when the pole is resting on the ground or floor.

Thus, an illuminated fishing rod solving the aforementioned problems is desired.

### SUMMARY OF THE INVENTION

The illuminated fishing rod includes an elongated, preferably hollow fishing rod having a handle end and a free end distal from the handle end. The elongated fishing rod is preferably made from a flexible material. An elongated hollow handle includes a forward end secured to the fixed end of the rod. First and second light sources are disposed on the elongated hollow handle. The first light source is aligned along a first radial projection from an axial center of the elongated hollow handle. The second light source is aligned along a second radial projection from the axial center of the elongated hollow handle. The first and second light sources project first and second light beams, respectively, away from the hollow handle. A third light source is attached to the rod proximate the free distal end. The third light source projects a third light beam away from the free distal end of the elongated, hollow fishing rod. The third light source projects light that has a different color from the light projected by the first light source. Moreover, the third light source projects light that has a different color from the light projected by the second light source.

These and other features of the present invention will become readily apparent upon further review of the following specification and drawings.

### BRIEF DESCRIPTION OF THE DRAWINGS

FIG. 1 is an environmental, perspective view of an illuminated fishing rod according to the present invention.

FIG. 2 is a partially exploded, perspective view of the illuminated fishing rod according to the present invention.

FIG. 3 is a partially exploded, perspective view of handle portion of the illuminated fishing rod according to the present invention.

FIG. 4 is a partially exploded perspective view of a battery pack handle and battery pack utilized in the illuminated fishing rod according to the present invention.

FIG. 5 is a partially exploded, perspective view of the cylindrical battery pack flashlight utilized in the illuminated fishing rod according to the present invention.

FIG. 6 is a schematic diagram of an electrical circuit for the illuminated fishing rod according to the present invention.

FIG. 7 is a schematic diagram of an alternative embodiment of an electrical circuit for the illuminated fishing rod according to the present invention having a removable battery pack-flashlight combination.

FIG. 8 is a schematic diagram of the removable battery pack-flashlight combination used in the circuit of FIG. 7.

Similar reference characters denote corresponding features consistently throughout the attached drawings.

### DETAILED DESCRIPTION OF THE PREFERRED EMBODIMENTS

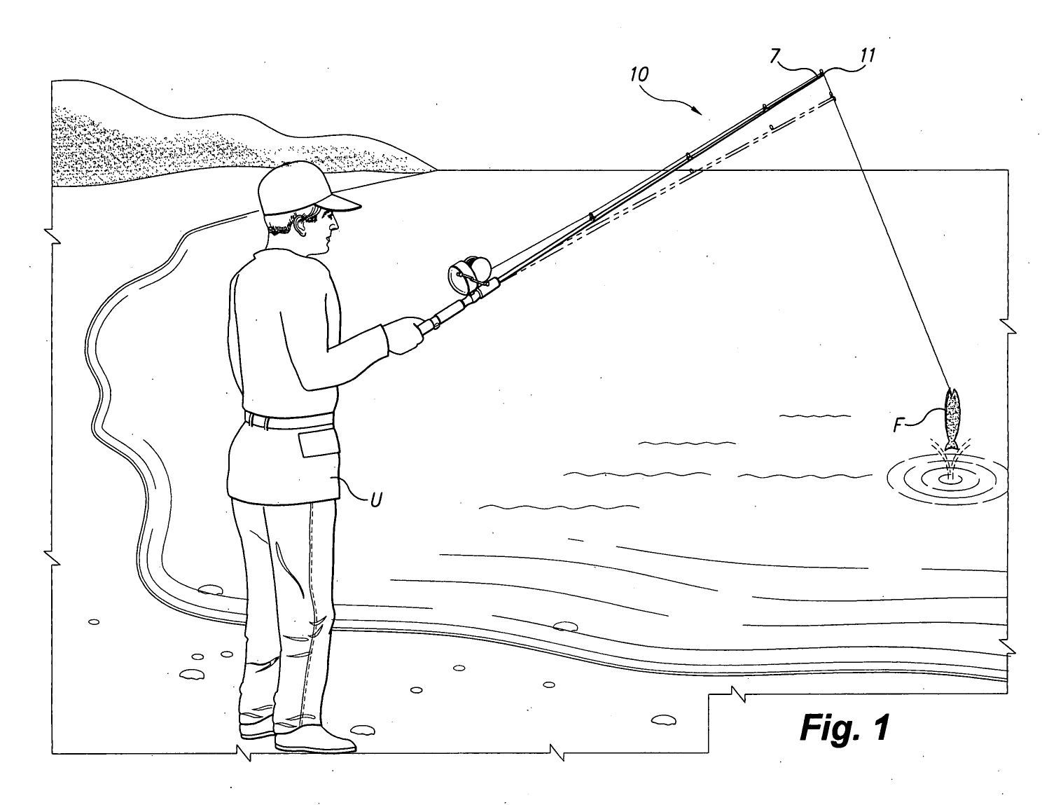

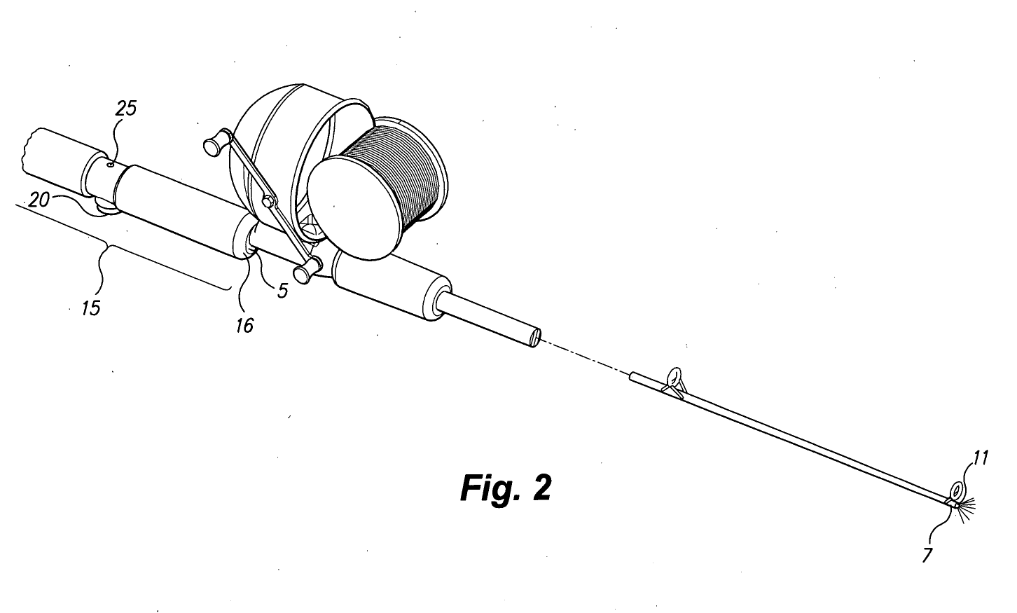

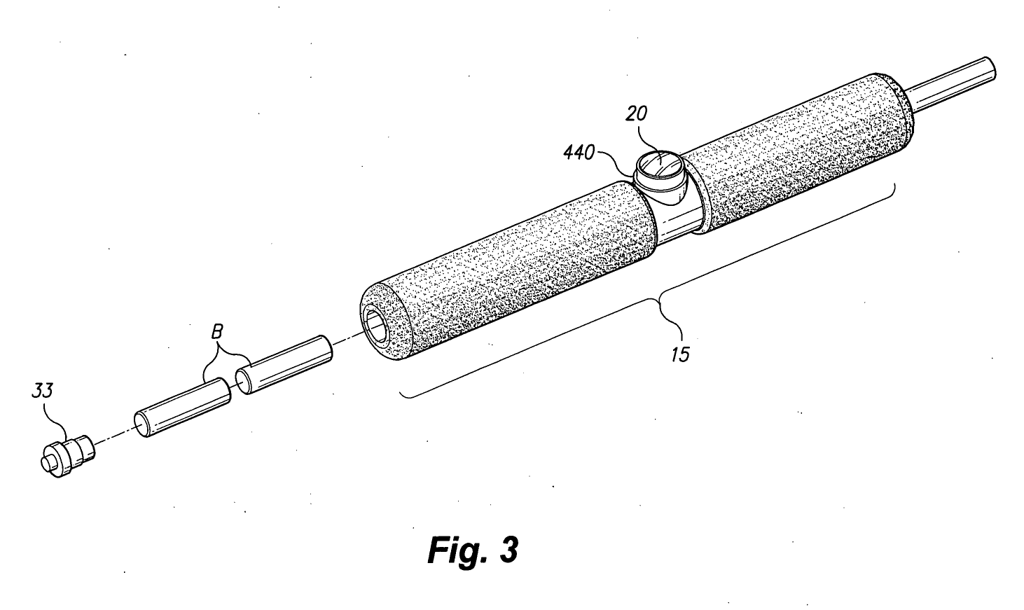

As shown in FIG. 1, a user U can fish using the illuminated fishing rod 10 and be made aware of a bite, i.e., strike from fish F by undulation of light source 11 disposed at the end of the rod 7. As most clearly shown in FIGS. 2-3, the illuminated fishing rod includes an elongated, preferably hollow, fishing rod having a handle end 5 and a free end 7 distal from the handle end. Strike light 11 is disposed proximate the free distal end 7. The elongated fishing rod is preferably made from a flexible material. An elongated, preferably hollow, handle 15 includes a forward end 16 secured to the handle end 5 of the rod. First and second light sources 20, 25 are disposed on the elongated, preferably hollow handle 15. Light source 20 is preferably a broad, area-illuminating light, while light source 25 may be more of a point or narrower beam light source. As shown in FIG. 3, light source 20 may be secured to the handle 15 by a threaded lens housing 440. The threaded lens housing 440 may be adjusted to change focal length of light beam projected from light source 20.

The first light source 20 is aligned along a first radial projection from an axial center of the elongated hollow handle 15. The second light source 25 is aligned along a second radial projection from the axial center of the elongated handle 15. The first and second light sources 20, 25 project first and second light beams, respectively, away from the handle 15.

A third light source, i.e., strike light 11 is attached to the rod proximate the free distal end 7. The third light source 11 projects a third light beam away from the free distal end 7 of the elongated fishing rod 10. The third light source 11 projects light that has a different color from the light projected by the first light source 20 and the light projected by the second light source 25. Third light source 11 may be an LED or any other type of compact light source disposed on the rod 10 at or near the tip 7 of the fishing rod. Broad, area-illuminating light 20 is preferably aligned in the handle along a radial projection 180° from the radial projection that LED point/narrow beam light source 25 is aligned with. Power energizing circuitry is disposed in the handle 15 in a manner such that it can be activated with the same hand used to hold fishing rod 10.

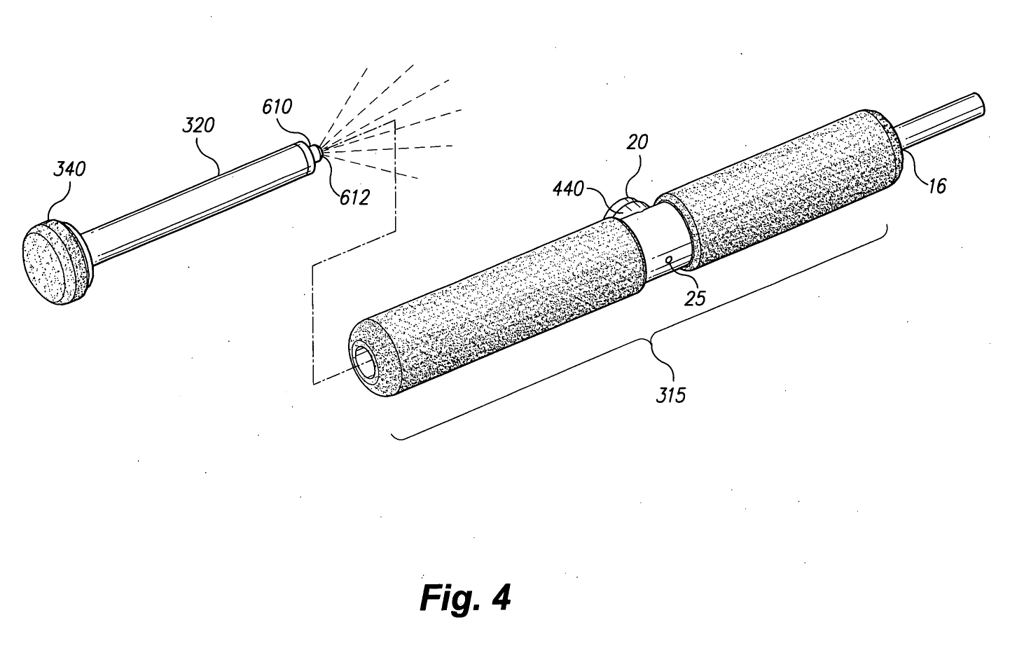

As shown in FIG. 3, power-energizing circuitry may include at least one battery B and conducting end cap 33. Alternatively, as shown in FIG. 4, the energizing circuitry may be disposed inside of hollow battery housing 320, the battery housing extending from battery housing end cap 340.

The preferably LED light sources 11 and 25 are preferably energized by the same circuit or power switch to provide a line of sight of the fishing rod 10 as an aid in darkness for determining which end of rod 10 is the handle end. For example without limitation, as an additional aid, light 25 has a different colored LED, bulb, or lens than the color LED, bulb, or lens of light 11 to ensure that a user safely picks up the fishing rod at the handle end 5 instead of possibly causing damage when the rod 10 is lifted from the lighter tip end 7.

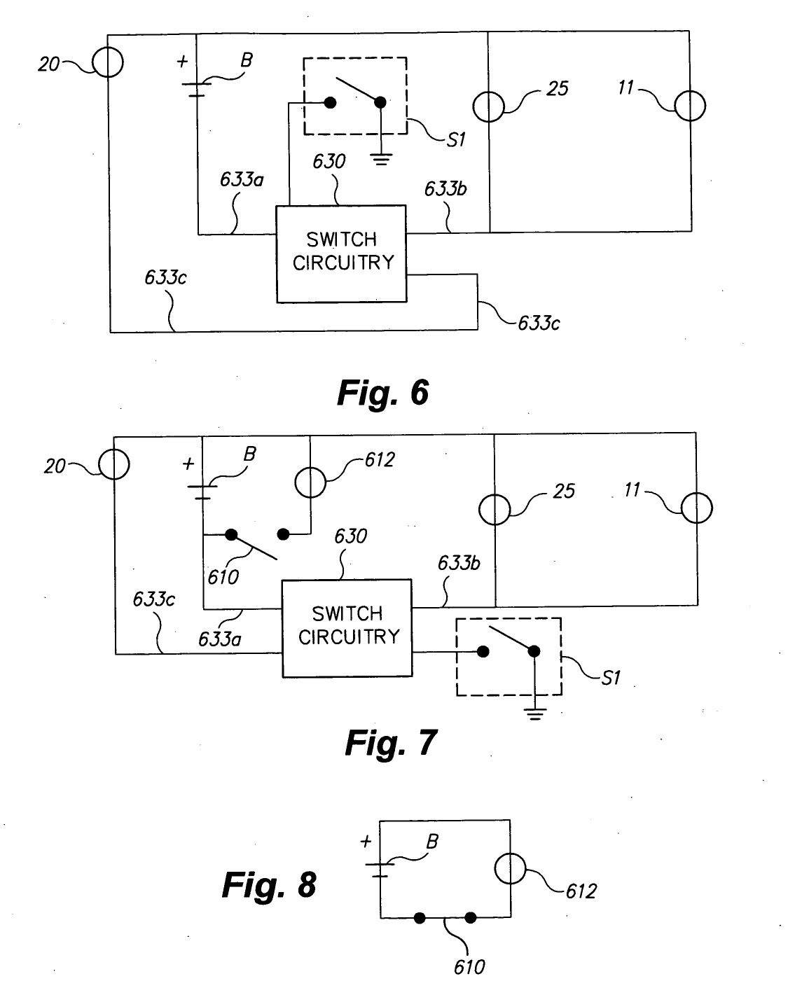

As shown in FIG. 6 the power energizing circuitry includes a battery B connected to switch circuitry 630 via line 633a. Power return line 633c connects broad beam light source 20 at the handle to the switch circuitry 630. Similarly, power return line 633b connects narrow beam light source 25 at the handle and tip light source 11 at tip 7 to the switch circuitry 630. Momentary switch S1 is connected as a control input to the switch circuitry 630. The switch circuitry 630 is preferably a digital logic circuit that energizes lights 25 and 11 responsive to a first press closing momentary switch S1, energizes light 20 responsive to a second press closing the switch S1, and de-energizes lights 11, 20, and 25 responsive to a third press closing the momentary switch S1.

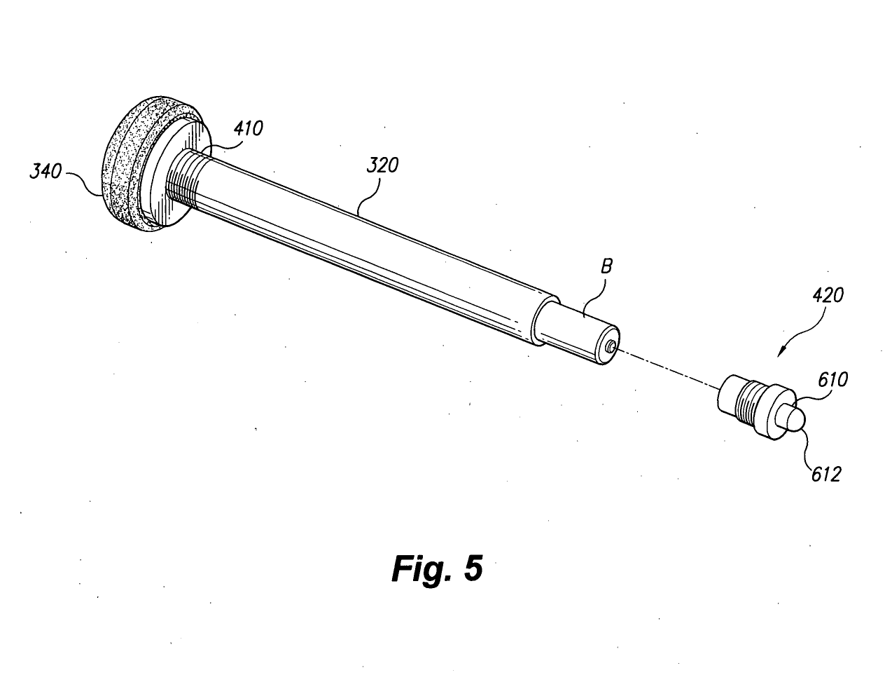

As shown in FIGS. 4-5, the power circuitry may be disposed in a hollow, elongate housing 320 attached to head unit 420 to form a conveniently removable, preferably rechargeable battery pack-flashlight combination. As shown in FIG. 8, the removable battery pack-flashlight combination may be shown schematically as including battery B, switch 610, and flashlight bulb 612. The housing 320 has a housing end cap 340 and attachment threads 410. If the battery(s) disposed in housing 320 is or are rechargeable, it is contemplated that a typical 12-volt automotive power outlet or a common household charger module may be used to recharge the pack.

FIG. 7 shows the alternative circuit diagram incorporating the removable battery pack-flashlight combination of FIG. 8. When the battery pack housing 320 is threaded into the battery pack compatible handle 315, a spring-biased switch 610 contacts an internal portion of handle 315, which thereby forces the switch 610 to an open position (as shown in FIG. 7), thereby de-energizing flashlight lamp 612. The inserted battery pack, however, is capable of energizing the light sources 25 and 11 and light source 20 via switch circuitry 630, as discussed above. As shown in FIG. 8 and most clearly shown in FIG. 4, when the battery housing is separate from handle 315, the spring-biased switch 610 is closed, thereby energizing flashlight source 612.

Referring to FIGS. 2 and 4, an elongate member extending from handle end 16 may be provided for insertion into rear portion 5 of an existing non-illuminated pole thereby retrofitting the non-illuminated pole to transform it into the illuminated rod 10.

The flashlight function, and particularly the orientation of the flashlight, can make the trek to one's favorite spot easier and lighter because an additional flashlight does not have to be carried to the location. The line of sight function that the LED's provide can also assist in differentiating one fishing rod from another should multiple fishing rods be used by an angler. The tip end LED 11 provides a measure of safety in crowded or limited space, such as a boat, pier, or crowded shoreline.

Moreover, the added weight to the handle 15 caused by handle light sources and associated energizing circuitry changes the position of the “center of balance” of the entire fishing rod 10. By moving the balance point closer to the hand that holds the fishing rod, the sensitivity of the tip end 7 is increased. In conjunction with the increased tip sensitivity, more of the larger muscle groups in the shoulders and arms of a user of rod 10 are used to hold the fishing rod 10, as opposed to wrist muscles doing the majority of the work, therefore reducing muscle fatigue of the wrist muscles.

For durability, a lightweight metal, such as aluminum, could be machined or cast for the main handle body components. A high-strength plastic or carbon composite could also be used. The major components are preferably covered using industry-standard, high-density closed-cell foam tubing.

It is to be understood that the present invention is not limited to the embodiment described above, but encompasses any and all embodiments within the scope of the following claims.

I claim:

1. An illuminated fishing rod, comprising:
an elongated fishing rod having a handle end and a free end opposite the handle end, the elongated fishing rod being made from a flexible material;
a handle having a forward end secured to the handle end of the fishing rod;
first and second light sources disposed on the handle, the first light source being aligned along a first radial projection from an axial center of the handle, the second light source being aligned along a second radial projection from the axial center of the handle, the first and second light sources projecting first and second light beams, respectively, away from the handle; and
a third light source attached to the rod proximate the free end, the third light source projecting a third light beam away from the free end of the fishing rod, the third light beam having a different color from both the first and second light beams, the third light source being energized and de-energized concurrently with the second light source.

2. The illuminated fishing rod according to claim 1, wherein said second light source is a narrow beam light source.

3. The illuminated fishing rod according to claim 1, wherein said first light source is a broad, area-illuminating light source.

4. The illuminated fishing rod according to claim 1, further comprising a power source disposed inside said handle, the power source selectively energizing said first, second and third light sources.

5. The illuminated fishing rod according to claim 4, wherein said power source has sufficient weight to move a balance point of said fishing rod toward said handle.

6. The illuminated fishing rod according to claim 4, further comprising:
a digital electronic control circuit disposed in said handle; and
a momentary electrical switch disposed in said handle, the momentary electrical switch being connected to an input of said digital electronic control circuit, outputs of said digital electronic control circuit being connected to said first, second, and third light sources;
wherein said digital electronic control circuit energizes said second light source and said third light source responsive to a first press closing said momentary electrical switch, and energizes said first light source responsive to a second press closing said momentary electrical switch, and de-energizes said first, second and third light sources responsive to a third press closing said momentary electrical switch.

7. The illuminated fishing rod according to claim 4, wherein said power source further comprises:
an elongate tubular battery compartment having a first end and a second end, the battery compartment being removably attachable to said handle;
a housing end cap disposed at the second end of the battery compartment; and
a head unit threadably attachable to the first end of the battery compartment, the head unit including a spring-biased switch connected to a fourth light source;
wherein when said power source is attached to said handle, said power source selectively energizes said first, second, and third light sources, and when said power source is removed from said handle, said power source energizes said fourth light source, thereby functioning as a flashlight.

8. The illuminated fishing rod according to claim 1, further comprising a threaded lens housing securing said first light source to said handle.

9. The illuminated fishing rod according to claim 8, wherein said threaded lens housing is adjustable to change focal length of said light beam projected from said first light source.

10. The illuminated fishing rod according to claim 8, wherein said handle is removably attachable to a standard fishing rod, thereby retrofitting the standard fishing rod to provide the standard fishing rod with illumination.
